(19) United States
(12) Patent Application Publication
(10) Pub. No.: US 2026/0087254 A1
(43) Pub. Date: Mar. 26, 2026

(54) METHOD FOR MERGING LANGUAGE MODELS AND APPARATUS FOR IMPLEMENTING THE SAME

(71) Applicant: SAMSUNG SDS CO., LTD., Seoul (KR)

(72) Inventors: Ho Young KANG, Seoul (KR); Bong Kyu HWANG, Seoul (KR); Soo Ah CHO, Seoul (KR); Jun Hwa CHOI, Seoul (KR); Seong Ho JOE, Seoul (KR)

(73) Assignee: SAMSUNG SDS CO., LTD., Seoul (KR)

(21) Appl. No.: 19/264,073

(22) Filed: Jul. 9, 2025

(30) Foreign Application Priority Data
Sep. 23, 2024 (KR) 10-2024-0128351
Apr. 22, 2025 (KR) 10-2025-0051990

(51) Int. Cl. G06F 40/284

(52) U.S. Cl. CPC G06F 40/284

(57) ABSTRACT

The present disclosure according to at least one embodiment provides a method for merging language models, performed by a computing system. The method comprises in response to receipt of a request to merge a first language model and a second language model, converting first embedding vectors corresponding to a first tokenizer used in the first language model and second embedding vectors corresponding to a second tokenizer used in the second language model by merging the first tokenizer and the second tokenizer, wherein the second tokenizer is different from the first tokenizer, repeatedly reducing components of each of the converted first embedding vectors and converted second embedding vectors through Singular Value Decomposition (SVD) until a preset performance threshold is reached, and merging the first and second language models using the reduced first embedding vectors and the reduced second embedding vectors.

### CROSS-REFERENCE TO RELATED APPLICATIONS

This application claims priority from Korean Patent Application No. 10-2024-0128351 filed on Sep. 23, 2024 and Korean Patent Application No. 10-2025-0051990 filed on Apr. 22, 2025 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method for merging language models and an apparatus for implementing the same, and more particularly, to a method for merging language models having different tokenizers, and an apparatus for implementing the same.

### 2. Description of the Related Art

Recently, extensive research has been conducted to obtain an optimal model that combines the capabilities of multiple models by merging two or more language models, particularly large language models (LLMs) and multimodal models. Technologies such as Task-Informed Ensemble Selection (TIES), Decoupled Algorithm for Robust Ensembling (DARE), and Spherical Linear Interpolation (SLERP) have been used as model merging techniques for combining different models, and methods applying genetic algorithms (GAs) to obtain optimal models are also being studied.

Language models such as LLMs and multimodal models decompose input data into tokens through tokenizers and convert the tokens into embedding vectors for input/output based on the token IDs in the vocabulary list. At this time, when tokenizers and the resulting embeddings differ, compatibility between models becomes difficult, making model merging challenging.

Such merging of language models has mainly been used between models with identical tokenizers and only minor differences in embeddings, for example, merging multiple models obtained by fine-tuning the Large Language Model Meta AI (LLaMA) for a specific task or domain, because the original models' performance may be lost during merging unless their tokenizers are identical.

In addition, when there are two models with identical tokenizers and only small differences between embedding vectors, the embedding vectors can be naturally merged through a weighted average method during the model merging process to create a new embedding. However, when tokenizers differ between models and embedding vectors are heterogeneously changed during the merging of the tokenizers, it can be perceived by the models as if the language itself has completely changed, resulting in a loss of the performance of the original models.

Conventionally, embedding vectors added to a merged tokenizer are typically initialized with arbitrary values or a new projection layer is added, followed by additional training. However, this requires additional computing resources for training and carries a significant risk of losing the original models' performance. Particularly, in cases where model merging must be repeated, such as in the genetic algorithm (GA) proposed by sakana AI, the consumption of computing resources may be even greater, imposing a heavier burden.

Therefore, a technology is needed that can efficiently merge models without additional training in cases where tokenizers differ or where differences between embedding vectors are large.

Moreover, there is a demand for a technology that enables new embeddings merged into the embeddings of a counterpart model to maintain the original models' performance without exerting a negative impact.

### SUMMARY

One objective of the present disclosure is to provide a method for merging language models and an apparatus for implementing the same, which enable efficient model merging without additional training even when tokenizers differ and the differences between embedding vectors are large during the merging of the language models.

Another objective of the present disclosure is to provide a method for merging language models and an apparatus for implementing the same, which enable model merging while minimizing the mutual influence between language models and maintaining the performance of the original language models as much as possible by using optimized embedding vectors during language model merging.

Yet another objective of the present disclosure is to provide a method for merging language models and an apparatus for implementing the same, which can minimize changes to existing language models and minimize resources used for training through efficient merging of tokenizers and embedding vectors during language model merging.

Still another objective of the present disclosure is to provide a method for merging language models and an apparatus for implementing the same, which can help improve language models by identifying embedding components that most significantly affect model performance during language model merging.

The objectives of the present disclosure are not limited to those mentioned above, and other objectives not explicitly stated will be clearly understood by those skilled in the art based on the following description.

According to an aspect of the present disclosure, there is provided a method for merging language models, performed by a computing system. The method comprises in response to receipt of a request to merge a first language model and a second language model, converting first embedding vectors corresponding to a first tokenizer used in the first language model and second embedding vectors corresponding to a second tokenizer used in the second language model by merging the first tokenizer and the second tokenizer, wherein the second tokenizer is different from the first tokenizer, repeatedly reducing components of each of the converted first embedding vectors and converted second embedding vectors through Singular Value Decomposition (SVD) until a preset performance threshold is reached, and merging the first and second language models using the reduced first embedding vectors and the reduced second embedding vectors.

In some embodiments, wherein the converting of the first embedding vectors corresponding to the first tokenizer and the second embedding vectors corresponding to the second tokenizer may comprise: merging a first vocabulary list of the first tokenizer and a second vocabulary list of the second tokenizer, expanding a dimension of the first embedding vectors and a dimension of the second embedding vectors to match whichever of the two dimensions is larger; tokenizing, via the first tokenizer, first added vocabulary items added to the first vocabulary list through the merging of the first and second vocabulary lists, and initializing the tokenized first added vocabulary items with an average value of corresponding embeddings, and tokenizing, via the second tokenizer, second added vocabulary items added to the second vocabulary list through the merging of the first and second vocabulary lists, and initializing the tokenized second added vocabulary items with an average value of corresponding embeddings.

In some embodiments, wherein the first embedding vectors may include a first input embedding vector that delivers an input value to a first layer among a plurality of layers of the first language model and a first output embedding vector that receives an output value from a last layer of the first language model, and the second embedding vectors may include a second input embedding vector that delivers an input value to a first layer among a plurality of layers of the second language model and a second output embedding vector that receives an output value from a last layer of the second language model.

In some embodiments, wherein the repeatedly reducing of the components of each of the converted first embedding vectors and converted second embedding vectors may comprise: obtaining bases corresponding to each of the first and second input embedding vectors by performing SVD on matrices of the first layers of the first and second language models; reducing components of each embedding vector by reducing a number of bases corresponding to each of the first and second input embedding vectors; terminating the reducing of the components of each embedding vector when a performance of each of the first and second language models reaches the preset performance threshold; and obtaining the reduced first input embedding vector and the reduced second input embedding vector.

In some embodiments, wherein the repeatedly reducing of the components of each of the converted first embedding vectors and converted second embedding vectors may comprise: obtaining bases corresponding to each of the first and second output embedding vectors by performing SVD on matrices of the last layers of the first and second language models; reducing components of each embedding vector by reducing a number of bases corresponding to each of the first and second output embedding vectors; terminating the reducing of the components of each embedding vector when the performance of each of the first and second language models reaches the preset performance threshold; and obtaining the reduced first output embedding vector and the reduced second output embedding vector.

In some embodiments, wherein the merging of the first and second language models may comprise: updating the first language model using the reduced first input and output embedding vectors; updating the second language model using the reduced second input and output embedding vectors; and merging the updated first and second language models.

According to another aspect of the present disclosure, there is provided a method for merging language models, performed by a computing system. The method comprises: merging a first vocabulary list of a first tokenizer used in a first language model and a second vocabulary list of a second tokenizer used in a second language model, wherein the second tokenizer is different from the first tokenizer, obtaining first embedding vectors corresponding to the first tokenizer and second embedding vectors corresponding to the second tokenizer using the merged first and second vocabulary lists, reducing components of each of the first embedding vectors and second embedding vectors until a preset performance threshold is reached, and merging the first and second language models using the reduced first embedding vectors and the reduced second embedding vectors.

In some embodiments, wherein the obtaining of the first embedding vectors corresponding to the first tokenizer and the second embedding vectors corresponding to the second tokenizer may comprise: tokenizing, via the first tokenizer, first added vocabulary items added to the first vocabulary list of the first tokenizer through the merging of the first and second vocabulary lists, and initializing the tokenized first added vocabulary items with an average value of corresponding embeddings; and tokenizing, via the second tokenizer, second added vocabulary items added to the second vocabulary list of the second tokenizer through the merging of the first and second vocabulary lists, and initializing the tokenized second added vocabulary items with an average value of corresponding embeddings.

In some embodiments, wherein the first embedding vectors may include a first input embedding vector that delivers an input value to a first layer among a plurality of layers of the first language model and a first output embedding vector that receives an output value from a last layer of the first language model, and the second embedding vectors may include a second input embedding vector that delivers an input value to a first layer among a plurality of layers of the second language model and a second output embedding vector that receives an output value from a last layer of the second language model.

In some embodiments, wherein the reducing of the components of each of the first and second embedding vectors may comprise: obtaining bases corresponding to each of the first and second input embedding vectors by performing SVD on matrices of the first layers of the first and second language models; reducing components of each embedding vector by reducing a number of bases corresponding to each of the first and second input embedding vectors; terminating the reducing of the components of each embedding vector when a performance of each of the first and second language models reaches the preset performance threshold; and obtaining the reduced first input embedding vector and the reduced second input embedding vector.

In some embodiments, wherein the merging of the first and second language models may comprise: updating the first language model using the reduced first input and output embedding vectors; updating the second language model using the reduced second input and output embedding vectors; and merging the updated first and second language models.

According to another aspect of the present disclosure, there is provided a system for merging language models, comprises: at least one processor, a memory configured to load a computer program executed by the at least one processor, and a storage configured to store the computer program, wherein the computer program includes instructions for performing operations of: in response to receipt of a request to merge a first language model and a second language model, converting first embedding vectors corresponding to a first tokenizer used in the first language model and second embedding vectors corresponding to a second tokenizer used in the second language model by merging the first tokenizer and the second tokenizer, wherein the second tokenizer is different from the first tokenizer; repeatedly reducing components of each of the converted first embedding vectors and converted second embedding vectors through Singular Value Decomposition (SVD) until a preset performance threshold is reached; and merging the first and second language models using the reduced first embedding vectors and the reduced second embedding vectors.

In some embodiments, wherein the operation of converting the first embedding vectors corresponding to the first tokenizer and the second embedding vectors corresponding to the second tokenizer may comprise: merging a first vocabulary list of the first tokenizer and a second vocabulary list of the second tokenizer; expanding a dimension of the first embedding vectors and a dimension of the second embedding vectors to match whichever of the two dimensions is larger; tokenizing, via the first tokenizer, first added vocabulary items added to the first vocabulary list through the merging of the first and second vocabulary lists, and initializing the tokenized first added vocabulary items with an average value of corresponding embeddings; and tokenizing, via the second tokenizer, second added vocabulary items added to the second vocabulary list through the merging of the first and second vocabulary lists, and initializing the tokenized second added vocabulary items with an average value of corresponding embeddings.

In some embodiments, wherein the first embedding vectors may include a first input embedding vector that delivers an input value to a first layer among a plurality of layers of the first language model and a first output embedding vector that receives an output value from a last layer of the first language model, and the second embedding vectors may include a second input embedding vector that delivers an input value to a first layer among a plurality of layers of the second language model and a second output embedding vector that receives an output value from a last layer of the second language model.

In some embodiments, wherein the operation of repeatedly reducing the components of each of the converted first embedding vectors and converted second embedding vectors may comprise: obtaining bases corresponding to each of the first and second input embedding vectors by performing SVD on matrices of the first layers of the first and second language models; reducing components of each embedding vector by reducing a number of bases corresponding to each of the first and second input embedding vectors; terminating the reducing of the components of each embedding vector when the performance of each of the first and second language models reaches the preset performance threshold; and obtaining the reduced first input embedding vector and the reduced second input embedding vector.

In some embodiments, wherein the operation of repeatedly reducing the components of each of the converted first embedding vectors and converted second embedding vectors may comprise: obtaining bases corresponding to each of the first and second output embedding vectors by performing SVD on matrices of the last layers of the first and second language models; reducing components of each embedding vector by reducing a number of bases corresponding to each of the first and second output embedding vectors; terminating the reducing of the components of each embedding vector when the performance of each of the first and second language models reaches the preset performance threshold; and obtaining the reduced first output embedding vector and the reduced second output embedding vector.

In some embodiments, wherein the operation of merging the first and second language models may comprise: updating the first language model using the reduced first input and output embedding vectors; updating the second language model using the reduced second input and output embedding vectors; and merging the updated first and second language models.

According to another aspect of the present disclosure, there is provided a system for merging language models, comprises: at least one processor, a memory configured to load a computer program executed by the at least one processor, and a storage configured to store the computer program, wherein the computer program includes instructions for performing operations of: merging a first vocabulary list of a first tokenizer used in a first language model and a second vocabulary list of a second tokenizer used in a second language model, wherein the second tokenizer is different from the first tokenizer; obtaining first embedding vectors corresponding to the first tokenizer and second embedding vectors corresponding to the second tokenizer using the merged first and second vocabulary lists; reducing components of each of the first embedding vectors and second embedding vectors until a preset performance threshold is reached; and merging the first and second language models using the reduced first embedding vectors and the reduced second embedding vectors.

In some embodiments, wherein the first embedding vectors may include a first input embedding vector that delivers an input value to a first layer among a plurality of layers of the first language model and a first output embedding vector that receives an output value from a last layer of the first language model, and the second embedding vectors may include a second input embedding vector that delivers an input value to a first layer among a plurality of layers of the second language model and a second output embedding vector that receives an output value from a last layer of the second language model.

In some embodiments, wherein the reducing of the components of each of the first and second embedding vectors may comprise: obtaining bases corresponding to each of the first and second input embedding vectors by performing SVD on matrices of the first layers of the first and second language models; reducing components of each embedding vector by reducing a number of bases corresponding to each of the first and second input embedding vectors; terminating the reducing of the components of each embedding vector when a performance of each of the first and second language models reaches the preset performance threshold; and obtaining the reduced first input embedding vector and the reduced second input embedding vector.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 illustrates the configuration of an overall system including a language model merging system according to an embodiment of the present disclosure;

FIG. 2 is a flowchart for explaining a method for merging language models according to an embodiment of the present disclosure;

FIG. 3 is a diagram illustrating an example of synthesis of vocabulary lists when merging tokenizers of two models according to some embodiments of the present disclosure;

FIG. 4 is a diagram illustrating an example of expansion of embeddings in accordance with the merging of tokenizers according to some embodiments of the present disclosure;

FIG. 5 is a diagram illustrating exemplary positions of embedding layers of two language models to be merged according to some embodiments of the present disclosure;

FIG. 6 is a diagram illustrating exemplary equations expressing Singular Value Decomposition (SVD) for input/output layers to be operated with embedding vectors and expressing the reduction of components of input and output embedding vectors according to some embodiments of the present disclosure;

FIG. 7 is a flowchart illustrating an overall model merging process through reduction of embedding components according to some embodiments of the present disclosure;

FIG. 8 is a flowchart for explaining a method for merging language models according to another embodiment of the present disclosure; and

FIG. 9 is a hardware configuration diagram of an exemplary computing system capable of implementing methods according to some embodiment of the present disclosure.

### DETAILED DESCRIPTION

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

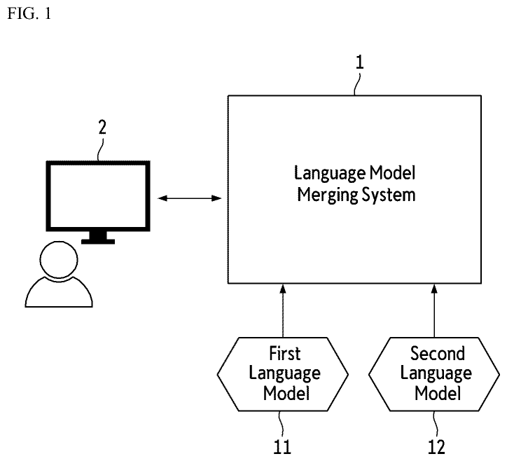

FIG. 1 illustrates the configuration of an overall system including a language model merging system according to an embodiment of the present disclosure.

Referring to FIG. 1, the overall system according to an embodiment of the present disclosure includes a language model merging system 1 and a user terminal 2, and the language model merging system 1 is connected to the user terminal 2 via a network. Here, the language model merging system 1 may be, for example, an application server, a cloud server, or a virtual server. The user terminal 2 may be, for example, a PC, a smartphone, a tablet, or a notebook computer. In addition, the language model merging system 1 may also be connected to other system components not illustrated in FIG. 1.

The language model merging system 1 is a system that performs a process for merging two or more language models, and generates and provides a new merged model by merging two or more different language models in response to a request from the user terminal 2. Although only a first language model 11 and a second language model 12 are illustrated in FIG. 1, the present disclosure is not limited thereto and may be applied to more than two language models.

Specifically, the language model merging system 1 receives a request for merging the first and second language models 11 and 12 from the user terminal 2. Each of the first and second language models 11 and 12 may be an RNN-based language model such as an RNN or an LSTM, or a Transformer-based language model such as LLaMA, GTP, GPT, BERT, or TS. In addition, each of the first and second language models 11 and 12 may also be a multimodal model such as GPT-4V, Flamingo, or Gemini.

First, prior to describing this embodiment, it is assumed that a first tokenizer of the first language model 11 and a second tokenizer of the second language model 12 are different from each other.

For the merging of the first and second language models 11 and 12, the language model merging system 1 first merges a first vocabulary list of the first tokenizer and a second vocabulary list of the second tokenizer, and may perform appropriate initialization for embedding vectors corresponding to vocabulary items newly added to each of the first and second tokenizers based on the merged vocabulary list.

As a result, the language model merging system 1 may obtain first embedding vectors and second embedding vectors of the first and second tokenizers that are updated according to the merging of the first and second vocabulary lists.

Subsequently, the language model merging system 1 reduces the components of each of the first embedding vectors and second embedding vectors of the first and second tokenizers through Singular Value Decomposition (SVD), thereby retaining only the most important components of each of the first embedding vectors and second embedding vectors. At this time, since the reduced first embedding vectors and the reduced second embeddings exhibit orthonormality, the first and second language models 11 and 12 may be merged while minimizing mutual influence therebetween.

According to the configuration of the overall system according to this embodiment as described above, when merging language models having different tokenizers, model merging may be performed while minimizing mutual influence between models and maintaining the performance of the original models as much as possible by using optimized embedding vectors. In addition, efficient merging of tokenizers and embedding vectors enables minimization of changes to the existing models and minimization of resources used for training.

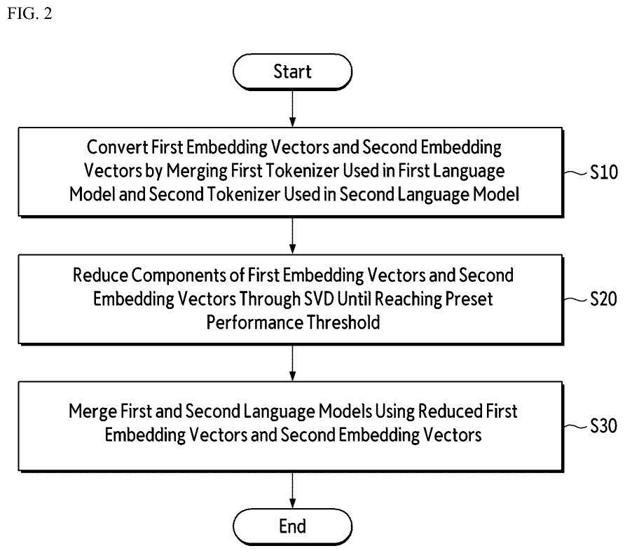

FIG. 2 is a flowchart for explaining a method for merging language models according to an embodiment of the present disclosure.

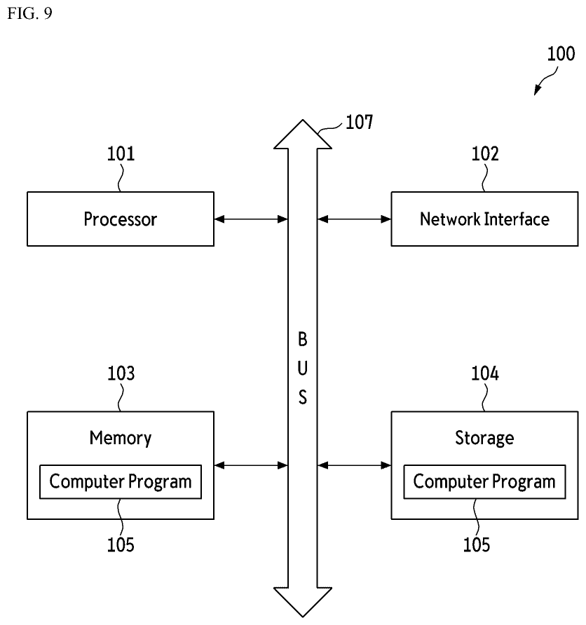

Referring to FIG. 2, the method for merging language models according to an embodiment of the present disclosure may be performed by the language model merging system 1 in FIG. 1 or a computing system 100 in FIG. 9. The computing system 100 may be, for example, an application server, a cloud server, or a virtual server.

It is to be noted that descriptions of the subjects performing some operations or steps in the method for merging language models according to an embodiment of the present disclosure may be omitted, and in such cases, the subjects should be understood as the computing system 100.

According to embodiments to be described below, when tokenizers differ and the differences between embedding vectors are large, models may be efficiently merged without additional training.

Referring to FIG. 2, first, in step S10, when a request for merging the first and second language models 11 and 12 is received, the computing system 100 merges the first tokenizer used in the first language model 11 and the second tokenizer used in the second language model 12, and converts first embedding vectors corresponding to the first tokenizer and second embedding vectors corresponding to the second tokenizer. Here, the second tokenizer may be different from the first tokenizer.

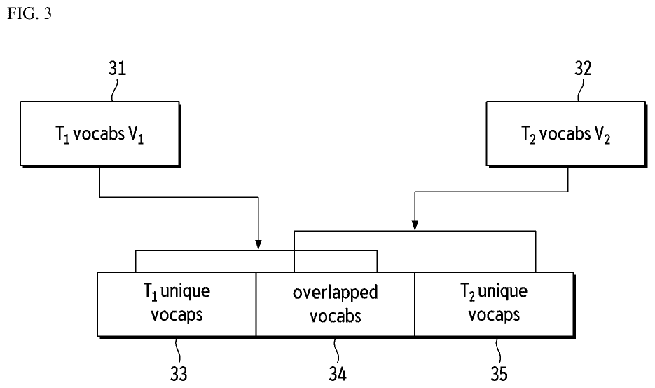

Referring to an example illustrated in FIG. 3, the first tokenizer of the first language model 11 is denoted as T₁, the second tokenizer of the second language model 12 is denoted as T₂, and first and second vocabulary lists 31 and 32 corresponding to the first and second tokenizers T₁ and T₂ are denoted as “T₁ vocabs V₁” and “T₂ vocabs V₂”, respectively.

When the first and second tokenizers T₁ and T₂ of the first and second language models 11 and 12 are merged, the first vocabulary list 31 of the first tokenizer T₁ and the second vocabulary list 32 of the second tokenizer T₂ are merged.

At this time, as a result of merging the first and second vocabulary lists 31 and 32, T₁ unique vocabulary items 33 that exist only in the first tokenizer T₁, T₂ unique vocabulary items 35 that exist only in the second tokenizer T₂, and overlapped vocabulary items 34 that exist in both the first and second tokenizers T₁ and T₂ may occur.

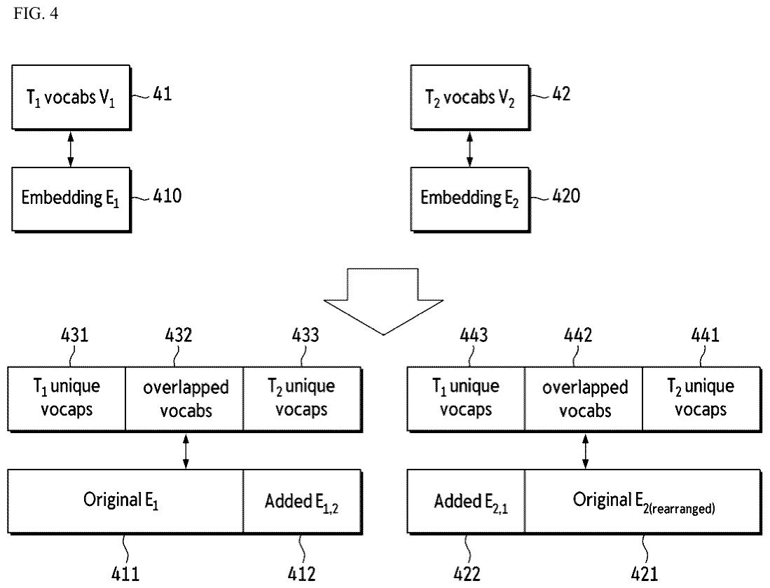

The process of expanding embedding vectors according to the merging of two tokenizers will hereinafter be described with reference to FIG. 4.

Referring to FIG. 4, when a first vocabulary list 41 (“T₁ vocabs V₁”) and a second vocabulary list 42 (“T₂ vocabs V₂”) are merged, based on the order of the vocabulary items in the first vocabulary list 41, the vocabulary items from the second vocabulary list 42 originating from the second language model 12 are treated as added vocabulary items V_{1,2}. At this time, since the IDs of T₂ unique vocabulary items 433 corresponding to the added vocabulary items V_{1,2} differ from the respective IDs in the original second vocabulary list 42, the order of first added embedding vectors 412 (“Added E_{1,2}”) corresponding to the T₂ unique vocabulary items 433 also needs to be rearranged. In addition, the size of an embedding layer, which aggregates embedding vectors through merging, also increases by the number of T2 unique vocabulary items 433. Here, the embedding layer refers to both an input embedding layer and an output embedding layer.

Subsequently, the T₂ unique vocabulary items 433 corresponding to the added vocabulary items V_{1,2} are tokenized by the first tokenizer T₁ of the first language model 11, and initialized with the average value of their corresponding embedding vectors.

For example, in the example of FIG. 3, when an added vocabulary item V_{1,2}, [‘hello’], is tokenized into [‘he’, ‘llo’] by the first tokenizer T₁, the embedding corresponding to ‘hello’ may be replaced with the arithmetic average of the embedding vectors corresponding to ‘he’ and ‘llo’.

Such initialization for the added vocabulary items V_{1,2} may also be performed using a weighted average or an appropriate projection instead of an arithmetic average method. Through this, the understanding of an existing model for added vocabulary items may be enhanced.

In one embodiment, appropriate initialization may be performed for some embedding vectors. Vocabulary items corresponding to special tokens may be removed or may be set to follow the standard of either the first tokenizer T₁ or the second tokenizer T₂ as needed. Additionally, for each added vocabulary items that are clearly intended to follow the performance of a specific one of the first and second language models 11 and 12, their embedding vectors may be initialized to zero. For example, when it is intended to adopt English performance from the first language model 11 and Korean performance from the second language model 12, Korean vocabulary items may be removed from the first tokenizer T₁ and English vocabulary items may be removed from the second tokenizer T₂, followed by the merging of the first and second tokenizers T₁ and T₂, and the embedding vectors of the resulting added vocabulary items may be initialized to zero.

According to the aforementioned embodiments, through the merging of the first and second vocabulary lists 41 and 42, final first embedding vectors may be obtained, including original first embedding vectors 411 (“Original E₁”) that reflect overlapped vocabulary items 432 in existing first embedding vectors 410 (“Embedding E₁”), and rearranged first added embedding vectors 412 (“Added E_{1,2}”).

Meanwhile, when merging the first and second vocabulary lists 41 and 42, if the first embedding vectors 410 of the first language model 11 and second embedding vectors 420 (“Embedding E₂”) of the second language model 12 have different dimensions, the smaller dimension must be expanded to match the larger dimension, and the expanded components are processed through zero padding. For example, if the first embedding vectors 410 of the first language model 11 have a dimension of 5 and the second embedding vectors 420 of the second language model 12 have a dimension of 3, the final first embedding vectors obtained through merging may be processed to have a dimension of 5.

Likewise, when merging the first and second vocabulary lists 41 and 42, based on the order of the vocabulary items in the second vocabulary list 42, the IDs of T₁ unique vocabulary items 443, which are added vocabulary items from the first language model 11, differ from the respective IDs in the original first vocabulary list 41, and the order of the second added embedding vectors 422 corresponding to the T₁ unique vocabulary items 443 is also rearranged.

In addition, the T₁ unique vocabulary items 443 corresponding to the added vocabulary items V_{2,1} are tokenized by the second tokenizer T₂ of the second language model 12 and initialized by the average value of their corresponding embedding vectors.

Consequently, final second embedding vectors may be obtained, including rearranged second added embedding vectors 422 (“Added E_{2,1}”) and original second embedding vectors 421 (“Original E_{2(rearranged)}”), rearranged by reflecting the overlapped vocabulary items 432 in the existing second embedding vectors 420.

Referring again to FIG. 2, in step S20, the computing system 100 repeatedly reduces the components of each of the converted first embedding vectors and converted second embedding vectors, obtained in step S10, through SVD until a preset performance threshold is reached. Here, the converted first embedding vectors and the converted second embedding vectors refer to the final first embedding vectors and the final second embedding vectors obtained through the merging of the first and second vocabulary lists 41 and 42 in the example of FIG. 4.

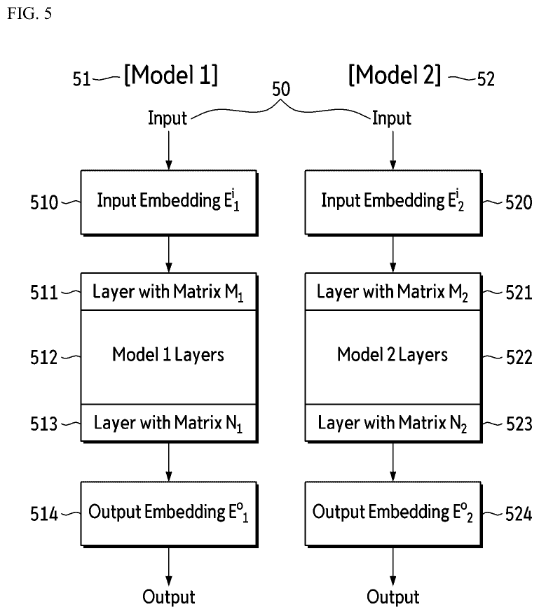

Step S20 will hereinafter be described in further detail with reference to FIG. 5. Referring to FIG. 5, an input signal 50 input into a first language model 51 (“Model 1”) is converted into an embedding vector by a first input embedding vector (510, “Eⁱ₁”) layer, and the embedding vector is multiplied by a matrix M₁ of a first layer 511 of the first language model 51. At this time, it is determined how the first language model 51 is to accept the input signal 51 through the first input embedding vector layer.

Thereafter, the input signal 51 passes through a plurality of layers 512 of the first language model 51, is multiplied by a matrix N₁ of a last layer 513 of the first language model 51, and the resulting output is converted into a per-vocabulary probability through a first output embedding vector (514, “E^{o}₁”) layer and finally converted into an output token.

Similarly, the input signal 50 input into a second language model 52 (“Model 2”) is converted into an embedding vector by a second input embedding vector (520, “Eⁱ₂) layer 520, and the embedding vector is multiplied by a matrix M₂ of a first layer 521 of the second language model 52. Subsequently, the input signal 50 passes through a plurality of layers 522 of the second language model 52, is multiplied by a matrix N₂ of a last layer 523 of the second language model 52, and the resulting output is converted into a per-vocabulary probability through a second output embedding vector (524, “E^{o}₂”) layer and finally converted into an output token.

In the example of FIG. 5, since the first and second language models 51 and 52 have the same structure, the matrices M₁ and M₂ will hereinafter be collectively referred to as M, and the matrices N₁ and N₂ will hereinafter be collectively referred to as N. Also, the first and second input embedding vectors Eⁱ₁ and Eⁱ₂ will hereinafter be referred to as Eⁱ, and the first and second output embedding vectors E^{o}₁ and E^{o}₂ will hereinafter be referred to as E°. At this time, it is assumed that the input embedding vectors Eⁱ (510 and 520) are n-dimensional, the matrices M (511 and 521) are m×n matrices, and the matrices N (513 and 523) are n×p matrices.

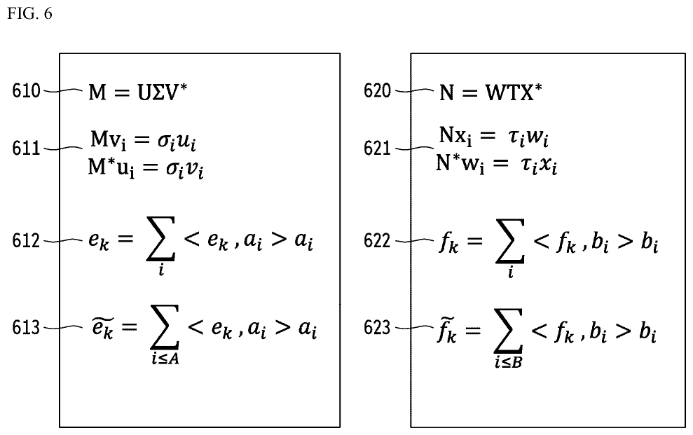

Referring to FIG. 6, when SVD is performed on a matrix M (e.g., 511 and 521), the matrix M may be decomposed as indicated by Equation 610, where A* denotes the conjugate transpose of a matrix A. SVD, which is a method for decomposing an arbitrary matrix into a product of three matrices, may be used for dimensionality reduction by selecting singular values.

In Equation 610, all columns of U become the left singular vectors of M, and all columns of V become the right singular vectors of M. For i (where i≤min(m, n)), the relationships of a column vector uᵢ of U and a column vector vᵢ of V with respect to a singular value σᵢ, which is the diagonal element of Σ, are as indicated by Equation 611.

At this time, an ordered orthonormal basis of an n-dimensional vector space including {vᵢ} may be constructed. A basis {aᵢ} of an input embedding space may be determined as the column vector vᵢ (where i≤min(m, n)). In this case, as shown in Equation 612, if an input embedding vector Eᵢ is defined as Eᵢ={eₖ}, the input embedding vector Eᵢ may be represented through projection onto the basis {aᵢ}.

According to Equation 612, the smaller the value of i, the larger singular value appears when multiplied by M, making the corresponding vector a more important component to be preserved in the input embedding vector Eᵢ.

Similarly, when SVD is performed on a matrix N (e.g., 513 and 523), the matrix N may be decomposed as shown in Equation 620. For i (where i≤min(n, p)), the relationships of a column vector wᵢ of W and a column vector xᵢ of X with respect to a singular value τᵢ, which is the diagonal element of T, are as indicated by Equation 621.

At this time, an ordered orthonormal basis of an n-dimensional vector space including {wᵢ} may be constructed. A basis {bᵢ} of an output embedding space may be determined as a column vector wᵢ (where i≤min(n, p)). In this case, as shown in Equation 622, if an output embedding vector Eₒ is defined as Eₒ={fₖ}, the output embedding vector Eₒ may be represented through projection onto the basis {bᵢ}.

According to Equation 622, the smaller the value of i, the larger singular value appears when multiplied by N, making the corresponding vector a more important component to be preserved in the output embedding vector Eₒ.

In this manner, the computing system 100 reduces the components of each of the input embedding vectors and output embedding vectors of the first and second language models 51 and 52 while simultaneously performing evaluation on the first and second language models 51 and 52. Through the evaluation of the first and second language models 51 and 52, each embedding vector expressed as a basis through SVD may be reduced to a minimum number of components.

Model evaluation may be performed using, for example, Harness evaluation in the case of an LLM or evaluation for a specific task. Various evaluation methods may also be used to perform model evaluation.

As an example, Harness evaluation, which is a framework for automatically evaluating an LLM by integrating various benchmarks, performs evaluation in the sequence of (1) prompt input, (2) model response, (3) comparison with the correct answer, and (4) quantification of performance. Through this, evaluation for a specific task (e.g., question answering, translation, summarization, code generation, etc.) may be quantitatively performed.

First, to reduce the components of the input embedding vector Eᵢ, when it is determined to preserve α % of a model performance H obtained through Harness evaluation, the computing system 100 may set a target model performance (or performance threshold) to H×α/100. Here, α may be set sufficiently high, considering the subsequent reduction of an output embedding vector.

At this time, the computing system 100 reduces a number A of components to be preserved among the components of the input embedding vector Eᵢ, until the model performance falls below H×α/100, as shown in Equation 613.

While gradually reducing the value of i in Equation 613, the computing system 100 performs model evaluation using the input embedding vector Eᵢ with reduced components, and stops the component reduction for the input embedding vector Eᵢ when the model performance reaches the target performance (or performance threshold) of H×α/100. Through this, the computing system 100 may obtain an input embedding vector Eᵢ retaining only a minimum of i components necessary to preserve the target performance.

Thereafter, the computing system 100 may perform component reduction for the output embedding vector Eₒ in the same manner as for the input embedding vector Eᵢ.

To reduce the components of the output embedding vector Eₒ, when it is determined through Harness evaluation to preserve β % (where β<α) of the performance H, the computing system 100 may set the target performance (or performance threshold) to H×β/100.

At this time, the computing system 100 reduces a number B of components to be preserved among the components of the output embedding vector Eₒ, until the model performance falls below H×β/100, as shown in Equation 623. That is, when the model performance reaches H×β/100, the component reduction for the output embedding vector Eₒ is terminated.

According to the aforementioned embodiments, when the components of each of the input and output embedding vectors (510 and 514) of the first language model 51 and the components of the input and output embedding vectors (520 and 524) of the second language model 52 are reduced through SVD, it is possible to confirm the orthonormality between the bases corresponding to the input and output embedding vectors (510 and 514) of the first language model 51 and the bases corresponding to the input and output embedding vectors (520 and 524) of the second language model 52.

Thereafter, the computing system 100 performs an inner product operation on remaining vectors {aᵢ}_{i≤A} and {bᵢ}_{i≤B} of the first input and output embedding vectors 510 and 514 of the first language model 51 and remaining vectors {cᵢ}_{i≤C} and {dᵢ}_{i≤D} of the input and output embedding vectors 520 and 524 of the second language model 52, and performs model evaluation while eliminating basis vectors whose inner product values exceed a certain threshold. Through this, the influence between the components of one embedding vector and the components of another embedding vector may be minimized. Specifically, by calculating <aᵢ, cⱼ> and <bᵢ, dⱼ> for each of the remaining basis vectors, one of the two basis vectors in each i-j pair that results in an inner product value exceeding a certain ratio is eliminated.

Referring again to FIG. 2, in step S30, the computing system 100 merges the first and second language models by using the first and second embedding vectors with reduced components.

That is, in the example of FIG. 5, the first and second language models 51 and 52 may be updated using the input and output embedding vectors 510 and 514 of the first language model 51 and the input and output embedding vectors 520 and 524 of the second language model 52, respectively, with reduced components.

Here, the first and second language models 51 and 52 may minimize interference between their embedding vectors through component reduction while maintaining the target model performance.

Accordingly, by merging the first and second language models 51 and 52 including embedding vectors with reduced components, the computing system 100 may generate a response result to an input prompt from the merged model. In this case, a model merging method such as TIES, DARE, or SLERP may be used, and various other model merging methods may also be applied.

The aforementioned embodiment has been described as merging two language models, but may also be applied to three or more models.

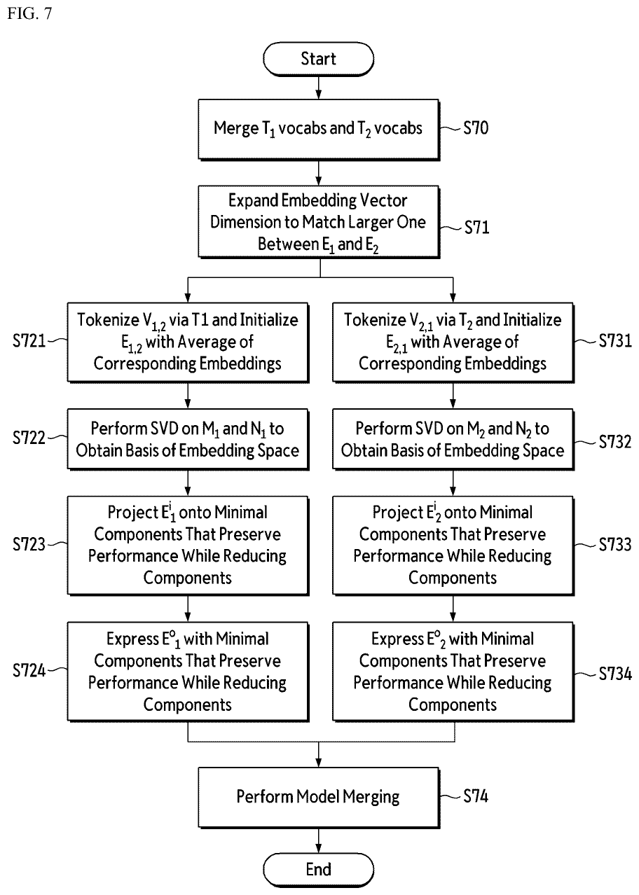

The merging of language models according to the above-described embodiments of the present disclosure can be summarized as illustrated in FIG. 7.

Referring to FIG. 7, first, the computing system 100 merges the first vocabulary list 41 (“V₁”) of the first tokenizer T₁ and the second vocabulary list 42 (“V₂”) of the second tokenizer T₂ (S70), and expands, through the merging, the dimensions of the first embedding vectors 410 (“E₁”) and the second embedding vectors 420 (“E₂”) to match whichever of the two dimensions is larger (S71).

Thereafter, the computing system 100 tokenizes added vocabulary items (V_{1,2} and V_{2,1}), added to the first and second vocabulary lists 41 and 42, respectively, through the merging of the first and second vocabulary lists 41 and 42, using the original first and second tokenizers T₁ and T₂, respectively, and initializes the added embedding vectors (E_{1,2} and E_{2,1}) with the corresponding embedding averages (S721 and S731).

Thereafter, the computing system 100 performs SVD on the matrices M₁ and N₁ of the first and last layers of the first language model 51, which operate with the input and output embedding vectors 510 and 514 (“Eⁱ₁” and “E^{o}₁”) of the first language model 51, and performs SVD on the matrices M₂ and N₂ of the first and last layers of the second language model 52, which operate with the input and output embedding vectors 520 and 524 (“Eⁱ₂” and “E^{o}₂”) of the second language model 52, thereby obtaining the bases of the embedding spaces for the first and second language models 51 and 52 (S722 and S732).

Thereafter, the computing system 100 performs projection with minimal components that can preserve performance, while reducing the components of each of the input embedding vectors 510 and 520 of the first and second language models 51 and 52 (S723 and S733). Similarly, the computing system 100 performs projection with minimal components that can preserve performance, while reducing the components of each of the output embedding vectors 514 and 524 of the first and second language models 51 and 52 (S724 and S734).

Finally, the computing system 100 updates each of the first and second language models 51 and 52 using input and output embedding vectors reduced to their minimal components and merges the updated first and second language models 51 and 52 (S74).

According to the aforementioned embodiments, language models may be merged without additional training even when they have different tokenizers and the differences between embedding vectors are large. Further, model merging may be performed while minimizing mutual influence between models and maintaining the performance of the original models as much as possible by using optimized embedding vectors with reduced components. In addition, during language model merging, embedding components that most significantly affect model performance may be identified, thereby aiding in model improvement. Moreover, through efficient merging of tokenizers and embedding vectors, changes to existing models may be minimized and resources used for training may also be minimized.

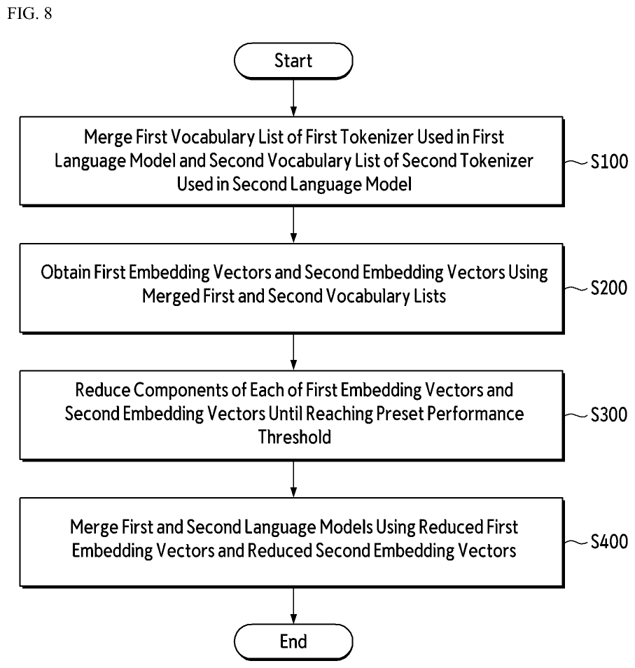

FIG. 8 is a flowchart for explaining a method for merging language models according to another embodiment of the present disclosure.

Referring to FIG. 8, the method for merging language models according to another embodiment of the present disclosure may be performed by the language model merging system 1 in FIG. 1 or the computing system 100 in FIG. 9. The computing system 100 may be, for example, an application server, a cloud server, or a virtual server.

It is to be noted that descriptions of the subjects performing some operations or steps in the method for merging language models according to another embodiment of the present disclosure may be omitted, and in such cases, the subjects should be understood as the computing system 100.

Referring to FIG. 8, first, in step S100, the computing system 100 merges a first vocabulary list of a first tokenizer used in a first language model and a second vocabulary list of a second tokenizer used in a second language model. Here, the second tokenizer may differ from the first tokenizer.

Thereafter, in step S200, the computing system 100 obtains first embedding vectors corresponding to the first tokenizer and second embedding vectors corresponding to the second tokenizer using the merged first and second vocabulary lists.

Here, the first embedding vectors may include a first input embedding vector Eⁱ₁ that delivers an input value to the first layer among a plurality of layers of the first language model and a first output embedding vector E^{o}₁ that receives an output value from the last layer of the first language model, and the second embedding vectors may include a second input embedding vector Eⁱ₂ that delivers an input value to the first layer among a plurality of layers of the second language model and a second output embedding vector E^{o}₂ that receives an output value from the last layer of the second language model.

As one embodiment, in step S200, the computing system 100 may tokenize first added vocabulary items V₁₂, which are added to a first vocabulary list V₁ of a first tokenizer T₁ through merging, using the first tokenizer T₁, and initialize the tokenized first added vocabulary items V₁₂ with the average value of the corresponding embedding vectors. Similarly, the computing system 100 may tokenize second added vocabulary items V₂₁, which are added to a second vocabulary list V₂ of a second tokenizer T₂, using the second tokenizer T₂, and initialize the tokenized second added vocabulary items V₂₁ with the average value of the corresponding embedding vectors.

Thereafter, in step S300, the computing system 100 reduces the components of each of the first embedding vectors and second embedding vectors until a preset performance threshold is reached.

As one embodiment, in step S300, the computing system 100 obtains bases corresponding to each of the first and second input embedding vectors by performing SVD on the matrices of the first layers of the first and second language models, and reduces the components of each embedding vector while reducing the number of bases corresponding to the first and second input embedding vectors. Here, when the performance of each of the first and second language models reaches the preset performance threshold, the computing system 100 may terminate the reduction of the components of each embedding vector.

Here, the method to reduce the components of each embedding vector is not limited to SVD, and various other methods such as PCA, Autoencoder, ICA, t-SNE, and UMAP may also be used. PCA is an arrangement method for maximizing variance through eigenvalue decomposition of a covariance matrix, and Autoencoder is a method of nonlinear compression using hidden layers of a neural network. Additionally, ICA is a method of maximizing the independence among components, t-SNE is a dimensionality reduction method that preserves local structures through probabilistic embedding vectors. Furthermore, UMAP is a topological structure-based dimensionality reduction method through the maintenance of data connectivity.

Through this, the computing system 100 may obtain the first and second input embedding vectors with reduced components.

Finally, in step S400, the computing system 100 merges the first and second language models using the reduced first embedding vectors and second embedding vectors.

As one embodiment, in step S400, the computing system 100 updates the first language model using the reduced first input and output embedding vectors, and updates the second language model using the reduced second input and output embedding vectors.

Then, the computing system 100 may merge the updated first and second language models.

According to the methods of the aforementioned embodiments, it is possible to perform model merging while minimizing mutual influence between models and maintaining the performance of the original models as much as possible by using optimized embedding vectors with reduced components.

FIG. 9 is a hardware configuration diagram of an exemplary computing system 100.

Referring to FIG. 9, the computing system 100 may include one or more processors 101, a bus 107, a network interface 102, a memory 103, which loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing system 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing system 100. The bus 107 may be implemented as various types of bus such as an address bus, a data bus and a control bus.

The network interface 102 supports wired and wireless internet communication of the computing system 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

As one embodiment, the computer program 105 may include instructions for performing the operations of: in response to receipt of a request to merge first and second language models, converting first embedding vectors corresponding to a first tokenizer used in the first language model and second embedding vectors corresponding to a second tokenizer used in the second language model by merging the first and second tokenizers, wherein the second tokenizer is different from the first tokenizer; repeatedly reducing the components of each of the converted first embedding vectors and converted second embedding vectors through SVD until a preset performance threshold is reached; and merging the first and second language models using the reduced first embedding and the reduced second embedding vectors.

As another embodiment, the computer program 105 may include instructions for performing the operations of: merging a first vocabulary list of a first tokenizer used in a first language model and a second vocabulary list of a second tokenizer used in a second language model, wherein the second tokenizer is different from the first tokenizer; obtaining first embedding vectors corresponding to the first tokenizer and second embedding vectors corresponding to the second tokenizer using the merged vocabulary lists; reducing the components of each of the first embedding vectors and second embedding vectors until a preset performance threshold is reached; and merging the first and second language models using the reduced first embedding vectors and the reduced second embedding vectors.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for merging language models, performed by a computing system, the method comprising:
in response to receipt of a request to merge a first language model and a second language model, converting first embedding vectors corresponding to a first tokenizer used in the first language model and second embedding vectors corresponding to a second tokenizer used in the second language model by merging the first tokenizer and the second tokenizer, wherein the second tokenizer is different from the first tokenizer;
repeatedly reducing components of each of the converted first embedding vectors and converted second embedding vectors through Singular Value Decomposition (SVD) until a preset performance threshold is reached; and
merging the first and second language models using the reduced first embedding vectors and the reduced second embedding vectors.

2. The method of claim 1, wherein the converting of the first embedding vectors corresponding to the first tokenizer and the second embedding vectors corresponding to the second tokenizer comprises: merging a first vocabulary list of the first tokenizer and a second vocabulary list of the second tokenizer; expanding a dimension of the first embedding vectors and a dimension of the second embedding vectors to match whichever of the two dimensions is larger; tokenizing, via the first tokenizer, first added vocabulary items added to the first vocabulary list through the merging of the first and second vocabulary lists, and initializing the tokenized first added vocabulary items with an average value of corresponding embeddings; and tokenizing, via the second tokenizer, second added vocabulary items added to the second vocabulary list through the merging of the first and second vocabulary lists, and initializing the tokenized second added vocabulary items with an average value of corresponding embeddings.

3. The method of claim 1, wherein
the first embedding vectors include a first input embedding vector that delivers an input value to a first layer among a plurality of layers of the first language model and a first output embedding vector that receives an output value from a last layer of the first language model, and
the second embedding vectors include a second input embedding vector that delivers an input value to a first layer among a plurality of layers of the second language model and a second output embedding vector that receives an output value from a last layer of the second language model.

4. The method of claim 3, wherein the repeatedly reducing of the components of each of the converted first embedding vectors and converted second embedding vectors comprises: obtaining bases corresponding to each of the first and second input embedding vectors by performing SVD on matrices of the first layers of the first and second language models; reducing components of each embedding vector by reducing a number of bases corresponding to each of the first and second input embedding vectors; terminating the reducing of the components of each embedding vector when performance of each of the first and second language models reaches the preset performance threshold; and obtaining the reduced first input embedding vector and the reduced second input embedding vector.

5. The method of claim 4, wherein the repeatedly reducing of the components of each of the converted first embedding vectors and converted second embedding vectors comprises: obtaining bases corresponding to each of the first and second output embedding vectors by performing SVD on matrices of the last layers of the first and second language models; reducing components of each embedding vector by reducing a number of bases corresponding to each of the first and second output embedding vectors; terminating the reducing of the components of each embedding vector when the performance of each of the first and second language models reaches the preset performance threshold; and obtaining the reduced first output embedding vector and the reduced second output embedding vector.

6. The method of claim 5, wherein the merging of the first and second language models comprises: updating the first language model using the reduced first input and output embedding vectors; updating the second language model using the reduced second input and output embedding vectors; and merging the updated first and second language models.

7. A method for merging language models, performed by a computing system, the method comprising:
merging a first vocabulary list of a first tokenizer used in a first language model and a second vocabulary list of a second tokenizer used in a second language model, wherein the second tokenizer is different from the first tokenizer;
obtaining first embedding vectors corresponding to the first tokenizer and second embedding vectors corresponding to the second tokenizer using the merged first and second vocabulary lists;
reducing components of each of the first embedding vectors and second embedding vectors until a preset performance threshold is reached; and
merging the first and second language models using the reduced first embedding vectors and the reduced second embedding vectors.

8. The method of claim 7, wherein the obtaining of the first embedding vectors corresponding to the first tokenizer and the second embedding vectors corresponding to the second tokenizer comprises: tokenizing, via the first tokenizer, first added vocabulary items added to the first vocabulary list of the first tokenizer through the merging of the first and second vocabulary lists, and initializing the tokenized first added vocabulary items with an average value of corresponding embeddings; and tokenizing, via the second tokenizer, second added vocabulary items added to the second vocabulary list of the second tokenizer through the merging of the first and second vocabulary lists, and initializing the tokenized second added vocabulary items with an average value of corresponding embeddings.

9. The method of claim 7, wherein
the first embedding vectors include a first input embedding vector that delivers an input value to a first layer among a plurality of layers of the first language model and a first output embedding vector that receives an output value from a last layer of the first language model, and
the second embedding vectors include a second input embedding vector that delivers an input value to a first layer among a plurality of layers of the second language model and a second output embedding vector that receives an output value from a last layer of the second language model.

10. The method of claim 9, wherein the reducing of the components of each of the first and second embedding vectors comprises: obtaining bases corresponding to each of the first and second input embedding vectors by performing SVD on matrices of the first layers of the first and second language models; reducing components of each embedding vector by reducing a number of bases corresponding to each of the first and second input embedding vectors; terminating the reducing of the components of each embedding vector when a performance of each of the first and second language models reaches the preset performance threshold; and obtaining the reduced first input embedding vector and the reduced second input embedding vector.

11. The method of claim 10, wherein the merging of the first and second language models comprises: updating the first language model using the reduced first input and output embedding vectors; updating the second language model using the reduced second input and output embedding vectors; and merging the updated first and second language models.

12. A system for merging language models, comprising:
at least one processor;
a memory configured to load a computer program executed by the at least one processor; and
a storage configured to store the computer program,
wherein the computer program includes instructions for performing operations of: in response to receipt of a request to merge a first language model and a second language model, converting first embedding vectors corresponding to a first tokenizer used in the first language model and second embedding vectors corresponding to a second tokenizer used in the second language model by merging the first tokenizer and the second tokenizer, wherein the second tokenizer is different from the first tokenizer; repeatedly reducing components of each of the converted first embedding vectors and converted second embedding vectors through Singular Value Decomposition (SVD) until a preset performance threshold is reached; and merging the first and second language models using the reduced first embedding vectors and the reduced second embedding vectors.

13. The system of claim 12, wherein the operation of converting the first embedding vectors corresponding to the first tokenizer and the second embedding vectors corresponding to the second tokenizer comprises: merging a first vocabulary list of the first tokenizer and a second vocabulary list of the second tokenizer; expanding a dimension of the first embedding vectors and a dimension of the second embedding vectors to match whichever of the two dimensions is larger; tokenizing, via the first tokenizer, first added vocabulary items added to the first vocabulary list through the merging of the first and second vocabulary lists, and initializing the tokenized first added vocabulary items with an average value of corresponding embeddings; and tokenizing, via the second tokenizer, second added vocabulary items added to the second vocabulary list through the merging of the first and second vocabulary lists, and initializing the tokenized second added vocabulary items with an average value of corresponding embeddings.

14. The system of claim 12, wherein
the first embedding vectors include a first input embedding vector that delivers an input value to a first layer among a plurality of layers of the first language model and a first output embedding vector that receives an output value from a last layer of the first language model, and
the second embedding vectors include a second input embedding vector that delivers an input value to a first layer among a plurality of layers of the second language model and a second output embedding vector that receives an output value from a last layer of the second language model.

15. The system of claim 14, wherein the operation of repeatedly reducing the components of each of the converted first embedding vectors and converted second embedding vectors comprises: obtaining bases corresponding to each of the first and second input embedding vectors by performing SVD on matrices of the first layers of the first and second language models; reducing components of each embedding vector by reducing a number of bases corresponding to each of the first and second input embedding vectors; terminating the reducing of the components of each embedding vector when a performance of each of the first and second language models reaches the preset performance threshold; and obtaining the reduced first input embedding vector and the reduced second input embedding vector.

16. The system of claim 15, wherein the operation of repeatedly reducing the components of each of the converted first embedding vectors and converted second embedding vectors comprises: obtaining bases corresponding to each of the first and second output embedding vectors by performing SVD on matrices of the last layers of the first and second language models; reducing components of each embedding vector by reducing a number of bases corresponding to each of the first and second output embedding vectors; terminating the reducing of the components of each embedding vector when the performance of each of the first and second language models reaches the preset performance threshold; and obtaining the reduced first output embedding vector and the reduced second output embedding vector.

17. The system of claim 16, wherein the operation of merging the first and second language models comprises: updating the first language model using the reduced first input and output embedding vectors; updating the second language model using the reduced second input and output embedding vectors; and merging the updated first and second language models.

18. A system for merging language models, comprising:
at least one processor;
a memory configured to load a computer program executed by the at least one processor; and
a storage configured to store the computer program,
wherein the computer program includes instructions for performing operations of: merging a first vocabulary list of a first tokenizer used in a first language model and a second vocabulary list of a second tokenizer used in a second language model, wherein the second tokenizer is different from the first tokenizer; obtaining first embedding vectors corresponding to the first tokenizer and second embedding vectors corresponding to the second tokenizer using the merged first and second vocabulary lists; reducing components of each of the first embedding vectors and second embedding vectors until a preset performance threshold is reached; and merging the first and second language models using the reduced first embedding vectors and the reduced second embedding vectors.

19. The system of claim 18, wherein
the first embedding vectors include a first input embedding vector that delivers an input value to a first layer among a plurality of layers of the first language model and a first output embedding vector that receives an output value from a last layer of the first language model, and
the second embedding vectors include a second input embedding vector that delivers an input value to a first layer among a plurality of layers of the second language model and a second output embedding vector that receives an output value from a last layer of the second language model.

20. The system of claim 19, wherein the reducing of the components of each of the first and second embedding vectors comprises: obtaining bases corresponding to each of the first and second input embedding vectors by performing SVD on matrices of the first layers of the first and second language models; reducing components of each embedding vector by reducing a number of bases corresponding to each of the first and second input embedding vectors; terminating the reducing of the components of each embedding vector when a performance of each of the first and second language models reaches the preset performance threshold; and obtaining the reduced first input embedding vector and the reduced second input embedding vector.
